(19) United States
(12) Patent Application Publication
(10) Pub. No.: US 2014/0298219 A1
(43) Pub. Date: Oct. 2, 2014

(54) Visual Selection and Grouping

(71) Applicant: Microsoft Corporation, Redmond, WA (US)

(72) Inventors: Ishita Kapur, Seattle, WA (US); Henri-Charles Machalani, Seattle, WA (US); Marina Dukhon Taylor, Kirkland, WA (US); Peter J. Kreiseder, Redmond, WA (US); John C. Whytock, Portland, OR (US); Adrian J. Garside, Sammamish, WA (US); Roy H. Berger, Seattle, WA (US); Bryan J. Mishkin, Bellevue, WA (US); Holger Kuehnle, Seattle, WA (US); Harold S. Gomez, Seattle, WA (US); Alice P. Steinglass, Bellevue, WA (US); Hui-Chun Ku, Bellevue, WA (US); Nazia Zaman, Kirkland, WA (US); Chantal M. Leonard, Seattle, WA (US)

(21) Appl. No.: 13/854,017

(22) Filed: Mar. 29, 2013

(51) Int. Cl. G06F 3/0484; G06F 3/0482

(52) U.S. Cl. CPC G06F 3/04842; G06F 3/0482
USPC 715/765

(57) ABSTRACT

Techniques for visual selection and grouping are described. In at least some embodiments, multiple visuals can be selected and grouped such that visuals can be manipulated as a group and various actions can be applied to visuals as a group. For example, in response to a user placing a group of visuals in a display region, the visuals can be arranged in the display region based on a specific arrangement order. According to one or more embodiments, visuals can be rearranged to reduce gaps between visuals, such as to present a consolidated view of visuals and to conserve display space. Visuals can be grouped together (e.g., based on user selection), and selectable options presented that are selectable to apply various actions to the grouped visuals.

### BACKGROUND

Today's computing devices provide users with rich user experiences. For example, users can utilize applications to perform tasks, such as word processing, email, web browsing, communication, and so on. Further, users can access a variety of content via a computing device, such as video, audio, text, and so on. Thus, computing devices provide a platform for access to a diverse array of functionalities and content.

To assist users in accessing various functionalities and/or content, computing devices typically present selectable visualizations that represent functionalities and/or content. For example, a user can select a visualization to launch an application, access an instance of content, access a computing resource, and so on. While such visualizations enable convenient access to functionalities and content, organization of visualizations in a display space presents challenges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for visual selection and grouping are described. Techniques discussed herein enable multiple visuals to be selected and grouped such that visuals can be manipulated as a group and various actions can be applied to visuals as a group. For example, a user can manipulate selected visuals as a group, such as by moving a representation of a visual group between regions of a display area. In response to a user placing the visual group in a display region, the visuals can be arranged based on a specific arrangement order. For instance, an order in which the visuals were displayed prior to being moved can be preserved after the visuals are moved.

According to one or more embodiments, visuals can be rearranged to reduce gaps between visuals, such as to present a consolidated view of visuals and to conserve display space.

According to one or more embodiments, visuals can be grouped together (e.g., based on user selection), and selectable options presented that are selectable to apply various actions to the grouped visuals. Actions that are available for selection for a group of visuals can be filtered based on attributes of the visuals included in the group.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example implementation scenario in accordance with one or more embodiments.

FIG. 3 illustrates an example implementation scenario in accordance with one or more embodiments.

FIG. 4 illustrates an example implementation scenario in accordance with one or more embodiments.

FIG. 5 illustrates an example implementation scenario in accordance with one or more embodiments.

FIG. 6 illustrates an example implementation scenario in accordance with one or more embodiments.

FIG. 7 is a flow diagram that describes steps in a method in accordance with one or more embodiments.

FIG. 8 is a flow diagram that describes steps in a method in accordance with one or more embodiments.

FIG. 9 is a flow diagram that describes steps in a method in accordance with one or more embodiments.

FIG. 10 illustrates an example system and computing device as described with reference to FIG. 1, which are configured to implement embodiments of techniques described herein.

### DETAILED DESCRIPTION

### Overview

Techniques for visual selection and grouping are described. Generally, a visual is a graphical representation that is selectable via user input to invoke various functionalities (e.g., applications, services, and so on), open instances of content, access resources (e.g., computer hardware resources), and so forth. Examples of visuals include icons, controls, tiles, and so forth. Visuals may also include instances of content, such as photographs. Techniques discussed herein enable multiple visuals to be selected and grouped such that visuals can be manipulated as a group and various actions can be applied to visuals as a group.

In at least some embodiments, visuals can be selected and grouped in a visual group. A user can manipulate the visuals as a group, such as by moving a graphical representation of the visual group between regions of a display area. For instance, grouped visuals can be moved within a current display area, and/or to other display areas that can be navigated to in various ways. In response to a user placing the visual group in a display region, the visuals can be arranged based on a specific arrangement order. For instance, an order in which the visuals were displayed prior to being moved can be preserved after the visuals are moved. Additionally or alternatively, other arrangement orders may be employed.

In response to a group of visuals being moved and placed, other visuals not included in the group can be rearranged to accommodate placement of the group of visuals. Thus, positioning of a user-selected group of visuals can be given priority over other visuals not expressly selected by a user.

According to one or more embodiments, visuals can be rearranged to reduce gaps between visuals, such as to present a consolidated view of visuals and to conserve display space. For example, a group of visuals can be inspected to identify gaps between the visuals. Visuals can be identified in the group that can be moved to fill the gaps, e.g., until no further gaps remain and/or no visuals remain that are of a suitable size to fill a remaining gap.

According to one or more embodiments, visuals can be grouped together (e.g., based on user selection), and selectable options presented that are selectable to apply various actions to the grouped visuals. For example, actions can be selected to be applied to applications associated with grouped visuals, such as uninstall, delete, and so forth. Actions may be applied to the visual attributes of visuals, such as resizing, activating, deactivating, and so on. Actions that are available for selection for a group of visuals can be filtered based on attributes of the visuals included in the group.

In the following discussion, an example environment is first described that is operable to employ techniques described herein. Next, a section entitled “Example Implementation Scenarios” describes some example implementation scenarios in accordance with one or more embodiments. Following this, a section entitled “Example Procedures” describes some example methods in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

### Example Environment

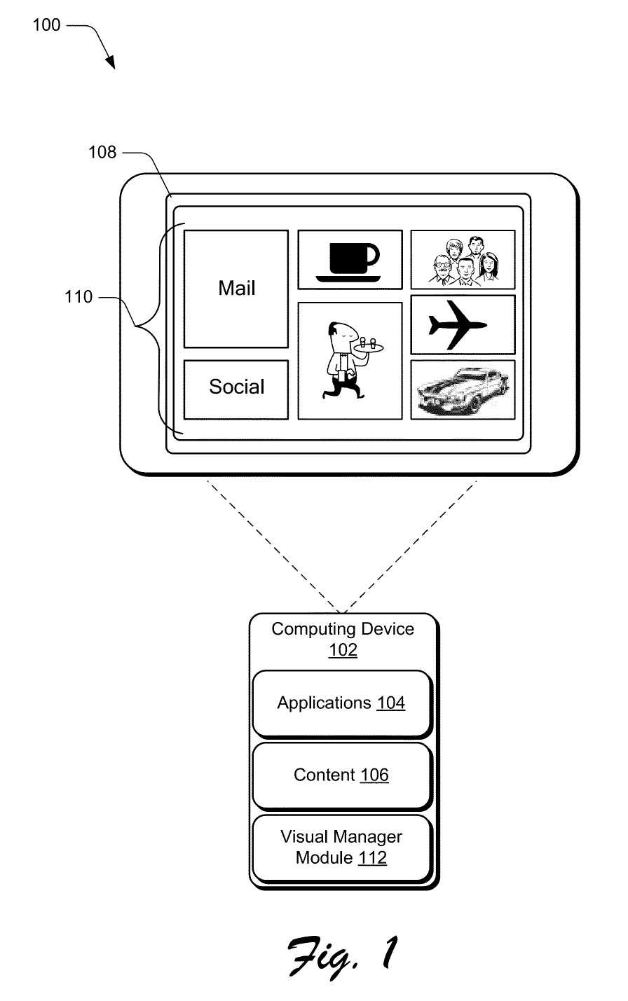

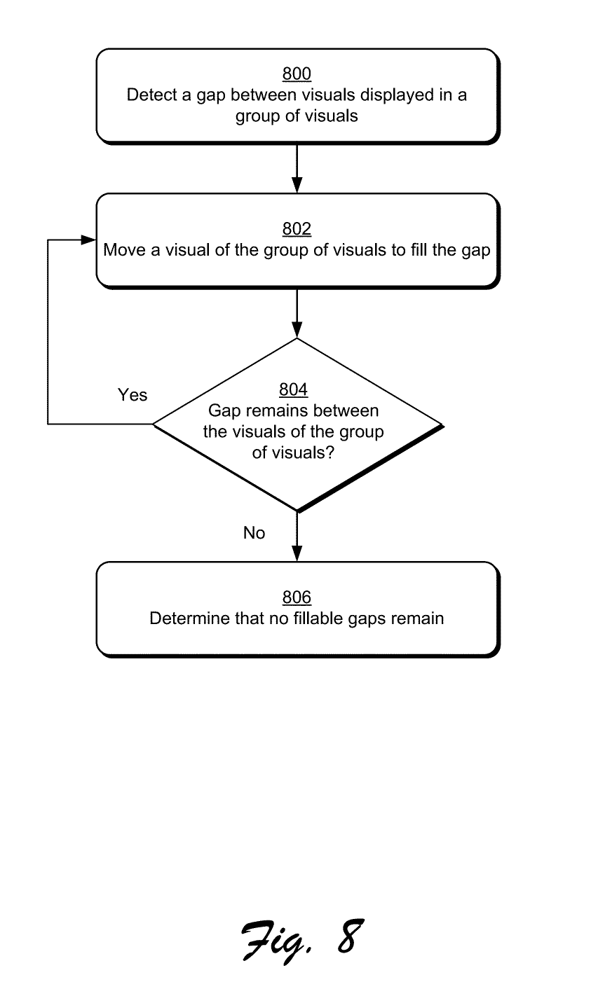

FIG. 1 is an illustration of an environment 100 in an example implementation that is operable to employ techniques for visual selection and grouping described herein. The illustrated environment 100 includes a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device (e.g., a tablet), and so forth as further described in relation to FIG. 8.

The computing device 102 includes applications 104 and content 106. The applications 104 are representative of functionalities to perform various tasks via the computing device 102. Examples of the applications 104 include a word processor application, an email application, a content editing application, a web browsing application, and so on. The content 106 is representative of instances of content that can be consumed via the computing device 102, such as images, video, audio, and so forth.

A display 108 is illustrated, which is configured to output graphics for the computing device 102. Displayed on the display 108 are visuals 110, which are graphical representations of functionalities, content, resources, and so forth. For instance, individual of the visuals 110 can be associated with respective instances of the applications 104 and/or the content 106. User selection of an individual of the visuals 110 can cause one of the applications 104 to be launched, an instance of the content 106 to be presented, and so on. Thus, as discussed herein, a visual generally refers to a visualization that is selectable to cause a variety of different actions to occur.

A visual manager module 112 is further included, which is representative of functionality to manage various aspects and attributes of the visuals 110. For instance, the visual manager module 112 can include functionality for implementing techniques for visual selection and grouping discussed herein. Further functionalities of the visual manager module 112 are discussed below.

Having described an example environment in which the techniques described herein may operate, consider now some example implementation scenarios in accordance with one or more embodiments.

### Example Implementation Scenarios

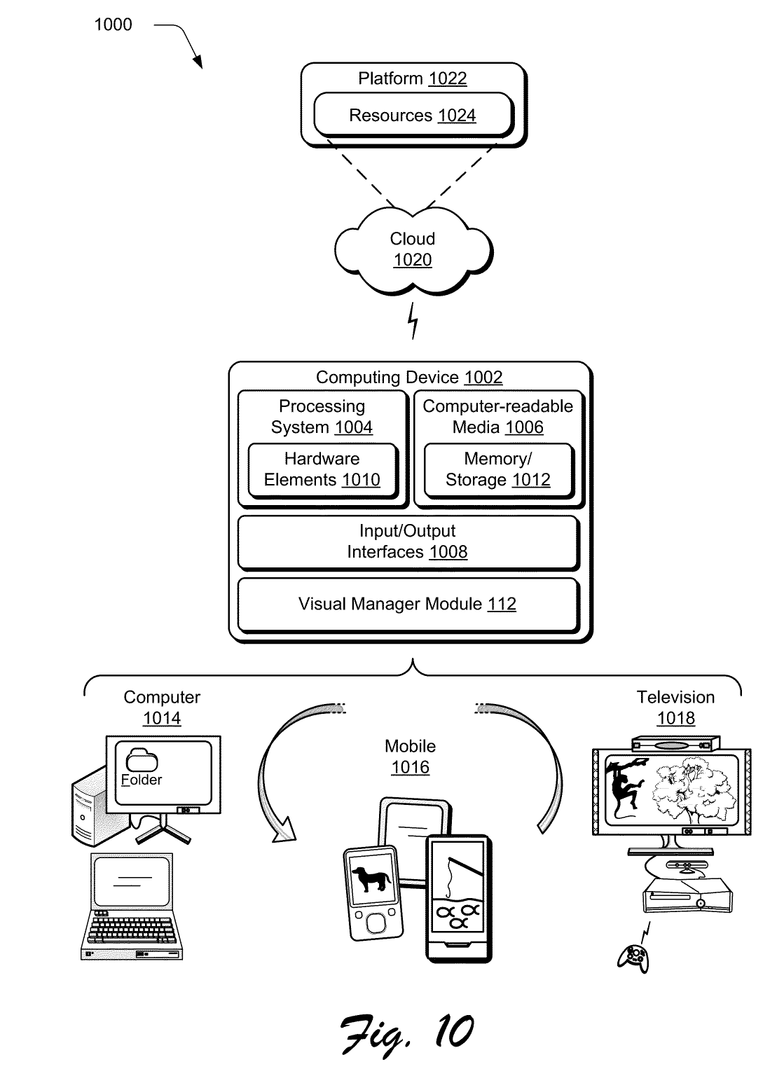

The following discussion describes some example implementation scenarios for visual selection and grouping in accordance with one or more embodiments. The example implementation scenarios may be employed in the environment 100 of FIG. 1, the system 1000 of FIG. 10, and/or any other suitable environment.

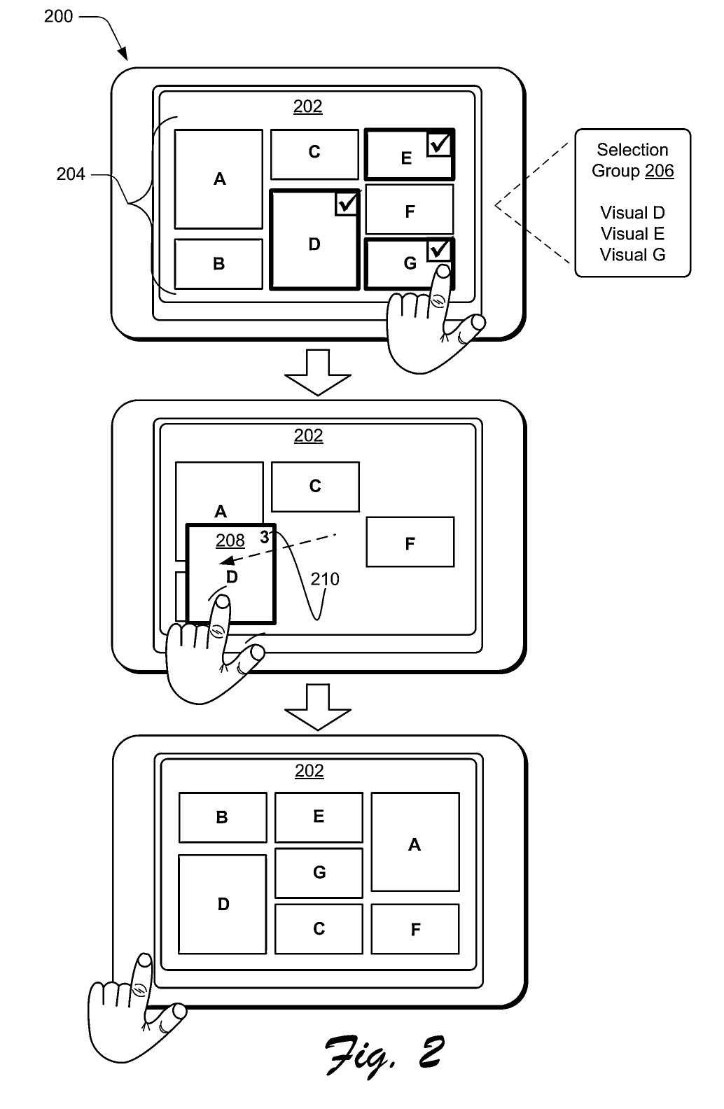

FIG. 2 illustrates an example implementation scenario, generally at 200. The upper portion of the scenario 200 includes a display area 202 that displays a group of visuals 204. As illustrated, each of the visuals 204 is identified by a respective letter designator. According to various embodiments, the display area 202 is scrollable (e.g., up, down, left, and/or right) to move the visuals 204 and/or to reveal other visuals not currently displayed.

According to various embodiments, the visuals 204 can be visualized as being organized in a grid structure on the display area 202. The grid structure, for example, can be utilized to specify an order for the individual visuals of the visuals 204. A Visual A, for example, can be first in the grid structure, with the remaining visuals following in the grid structure. In this example, the alphabetical order of the visuals corresponds to the grid order of the visuals. In at least some embodiments, the grid order of the visuals can be utilized to determine where visuals are to be placed when visuals are moved and/or rearranged in the display area 202.

Further illustrated in the upper portion of the scenario 200 is that some of the visuals 204 are selected to form a selection group 206 of the visuals 204, e.g., including a Visual D, a Visual E, and a Visual G. While the scenario 200 is illustrated with reference to the visuals of the selection group being selected via touch input to the display area 202, this is not intended to be limiting. According to various embodiments, visuals for a selection group can be selected via a variety of different input techniques, such as mouse input (e.g., mouse clicks), keyboard input, touchless gesture input, voice input, and so forth.

In at least some embodiments, selection of the visuals of the selection group 206 can occur while an associated computing device is in a multiple selection mode. For instance, a user can expressly invoke a multiple selection mode, e.g., via the visual manager module 112. Visuals that are selected while the multiple selection mode is active can be grouped together as part of a selection group, e.g., the selection group 206. Alternatively or additionally, a specific gesture (e.g., touch and/or touchless gesture) can be defined for multiple selection. Thus, when the specific gesture is applied to a visual, the visual can be designated as part of a selection group. Other ways of invoking multiple selection functionality are discussed below.

The upper portion of the scenario 200 further illustrates that selection of the visuals of the selection group 206 causes the visuals to be visually distinguished from others of the visuals 204 that are not included in the selection group 206. For example, the visuals of the selection group 206 can be visually highlighted, such as by bolding the visual borders. Also illustrated is that a checkmark is included in each of the visuals of the selection group 206, to further emphasize that the visuals are selected as part of a multiple visual selection operation.

In at least some embodiments, visuals of the selection group 206 can be organized based on the order in which the visuals are displayed. For instance, the selection group 206 lists the visuals in the order in which they are displayed, e.g., Visual D is selected first, Visual E second, and Visual G third. Display order is just one way of organizing visuals within a selection group, however, and a wide variety of different organization schemes can be employed to organize visuals within a selection group. For instance, visuals in a selection group can be organization based on an order in which the visuals are selected.

According to various embodiments, operations that are applied to visuals within a selection group can be based on visual order within the selection group. For example, an operation that is applied to the selection group 206 can first be applied to the Visual D, then to the Visual E, and then to the Visual G. Thus, organization of visuals within a visual group can affect how various operations are applied to the respective visuals.

Continuing to the center portion of the scenario 200, a user manipulates Visual D, such as by touching and dragging the visual away from its original display position. Various other types of input may be employed for manipulating visuals, examples of which are discussed elsewhere herein.

In response to Visual D being manipulated away from its original position on the display area 202, a number of different events can occur. For example, visuals of the selection group 206 are visually combined as part of a group visualization 208 that represents the selection group 206. Further, other visuals of the selection group 206 (e.g., Visual E and Visual G) are visually removed from the display area 202. The group visualization 208 includes a group indicator 210 that indicates a number of visuals represented by the group visualization 208.

The group visualization 210 is presented for purpose of example only, and a wide variety of graphical indicia of visual grouping can be employed in accordance with the claimed embodiments. For example, a group visualization can be illustrated as a staggered stack of visuals (e.g., a deck of visuals) that includes a number of visualizations currently selected. Various other indications of visual grouping can be utilized alternatively or in addition.

According to various embodiments, the group visualization 208 can be manipulated in various ways to cause different operations to be applied to visuals of the selection group 206, such as move operations, uninstall operations for applications associated with the visuals, delete operations, and so forth.

The center portion of the scenario 200 further illustrates that the group visualization 208 is manipulated such that is overlaps a Visual A and a Visual B.

Continuing to the lower portion of the scenario 200, the group visualization 208 is dropped. For example, a user can release touch input to the group visualization 208. Dropping the group visualization 208 at a new location (e.g., overlapping Visual A and Visual B) causes the visuals 204 to be visually rearranged. In at least some embodiments, a threshold visual overlap can be defined, such as with reference to an area of the Visual A and the Visual B that is overlapped by the group visualization 208, an amount of the group visualization 208 that overlaps other visuals, and so forth. Manipulating the group visualization 208 such that the threshold visual overlap is met or exceeded can cause various actions to occur, such as a visual rearrangement of visuals.

Further to the scenario 200, visual rearrangement of the visuals 204 is performed based on a variety of considerations. For instance, visuals are rearranged such that visuals included in the selection group 206 are visually grouped together in the display area 202. Further, an order in which the visuals of the selection group 206 were originally arranged prior to being moved can be preserved, such as using the grid visualization discussed above.

For example, consider the arrangement of the visuals in the upper portion of the scenario 200 prior to the visuals of the selection group 206 being moved. Visualizing the visuals as being arranged in order from the upper left corner of the display area 202 to the lower right corner of the display area 202, the visuals can be considered to be arranged serially (and in this example, alphabetically) starting with Visual A and proceeding through intermediate visuals to Visual G. Thus, visuals of the selection group 206 can be considered to have a visual order on the display area 202 of Visual D first, Visual E second, and Visual G third.

Returning to the lower portion of the scenario 200, visual rearrangement of the visuals 204 is based on the original visual order of the selection group 206. For instance, Visual D is positioned at the location at which the group visualization 208 is dropped. Visual E and Visual G are then arranged in positions that follow Visual D. Thus, the visuals of the selection group 206 are arranged such that other non-grouped visuals do not visually intervene in the visual order.

Further to the rearrangement, others of the visuals 204 are rearranged to accommodate the movement and arrangement of the selection group 206. For instance, user selection and placement of the selection group 206 is given priority, and positioning of other visuals not in the selection group 206 is performed such that positioning and placement of the selection group 206 via user input is preserved.

In at least some embodiments, positioning of other visuals not in the selection group 206 is based on both the original positions of the visuals prior to the rearrangement (e.g., as illustrated in the upper portion of the scenario 200), and available display area. For instance, consider the following scenario.

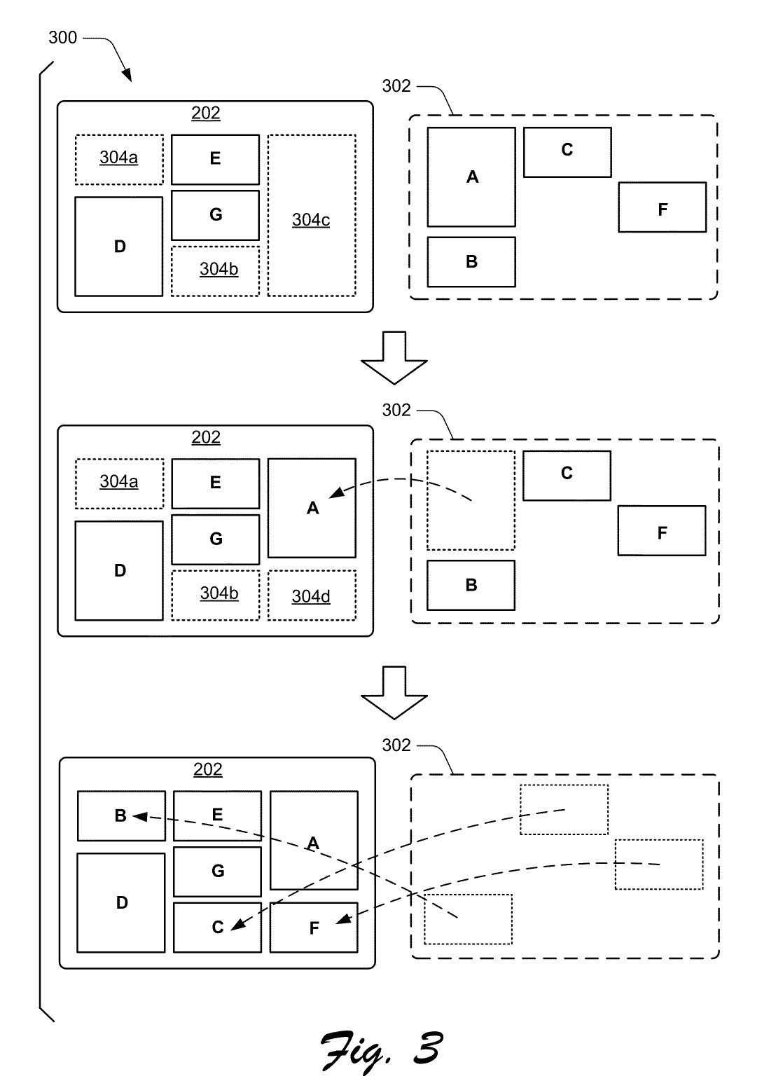

FIG. 3 illustrates an example implementation scenario, generally at 300. According to at least some embodiments, the scenario 300 illustrates example visual rearrangement logic utilized to rearrange visuals, such as with reference to the scenario 200 discussed above. Thus, the scenario 300 is discussed with reference to various aspects of the scenario 200.

The upper portion of the scenario 300 displays visuals of the selection group 206 (e.g., Visual D, Visual E, and Visual G introduced above) after the selection group 206 is moved and the respective visuals arranged, such as illustrated in the lower portion of the scenario 200. As discussed above, user selection and placement of visuals in a selection group is given priority. Thus, the visuals of the selection group 206 are placed in order in the display area 202, as discussed above.

After the Visuals D, E, and G are positioned based on user selection and placement, visuals 302 remain to be rearranged. Thus, other portions of the display area 202 are inspected to determine suitable rearrangement of remaining visuals 302 to preserve the positional priority of the selection group 206. Thus, the upper portion of the scenario 300 illustrates a region 304a, a region 304b, and a region 304c, which correspond to regions of the display area 202 that are available for placement of the visuals 302, e.g., visuals not in the selection group 206.

As referenced above, further to a visual rearrangement, positioning of the visuals 302 is based on both the original positions of the visuals 302 prior to the rearrangement (e.g., as illustrated in the upper portion of the scenario 200), and available display area. For instance, consider the visuals 302, e.g., Visual A, Visual B, Visual C, and Visual F. Starting with Visual A (e.g., first in the original visual order), iteration through the available placement regions 304a-304c occurs until a first available placement region is location that can accommodate Visual A. In this example, the region 304a and 304b are too small to accommodate Visual A without visually clipping some portion of the visual.

Continuing to the next portion of the scenario 300, the first suitable region encountered for placement of Visual A is region 304c. For example, the region 304c corresponds to an available placement region where Visual A can be placed without visually clipping a portion of the visual. Thus, Visual A is positioned in the first available portion of region 304c. After placement of the Visual A, the regions 304a and 304b remain, along with a region 304d that corresponds to a portion of the region 304c remaining after Visual A is placed.

Visual B, Visual C, and Visual F of the visuals 302 remain to be placed in the display area 202. Using a similar process as discussed above with reference to Visual A, iteration through the remaining visuals occurs and based on the first available region in which a respective visual will fit.

Continuing with this process and to the lower portion of the scenario 300, Visual B is placed in the region 304a, Visual C is placed in the region 304b, and Visual F is placed in the region 304d. Thus, a visual rearrangement of visuals occurs that gives priority to user-indicated grouping and placement of visuals. Visual rearrangement of visuals that are not grouped by a user can be performed based on space remaining after user-selected visuals are placed, an original visual order for remaining visuals, and space constraints for visual placement.

According to various embodiments, user manipulation of grouped visuals can be displayed in various ways. For instance, consider the following scenario.

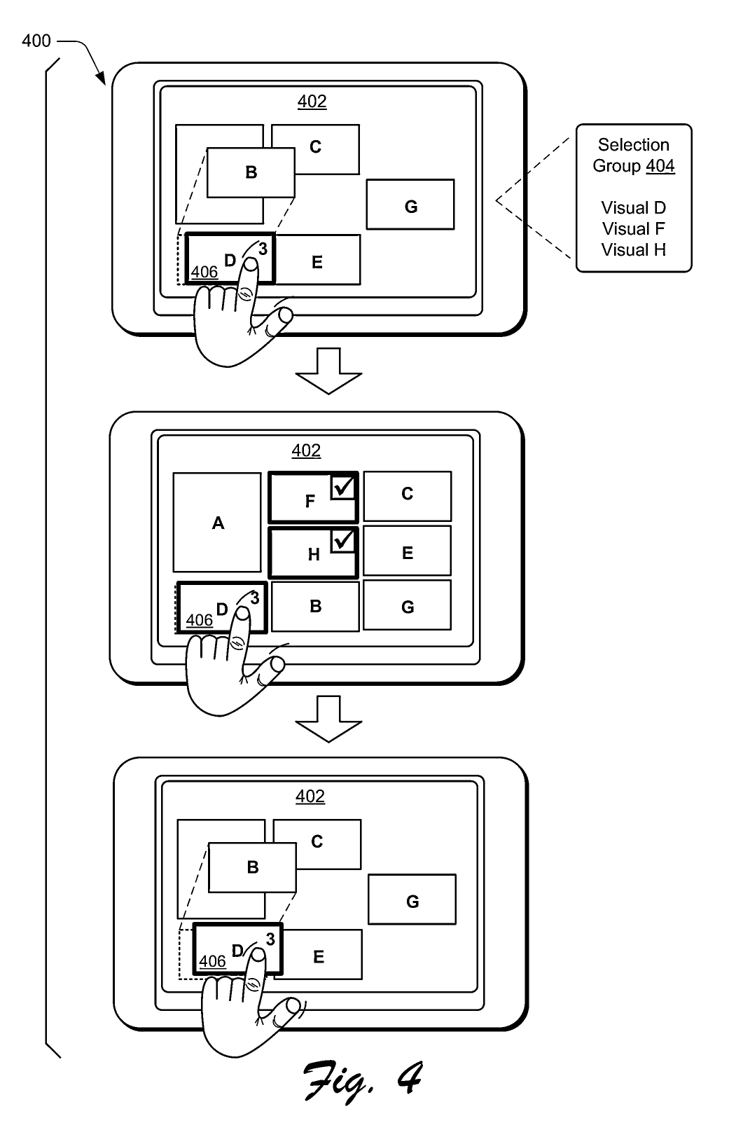

FIG. 4 illustrates an example implementation scenario, generally at 400. In the upper portion of the scenario 400, a user has selected several visualizations displayed on a display area 402 to form a selection group 404, e.g., a Visual D, a Visual F, and a Visual H. In response user manipulation of the Visual D, a group visualization 406 is presented that represents the selection group 404. As further illustrated, the user manipulates the group visualization 406 on the display area 402 to overlap a Visual B not included in the selection group 404.

In response to the group visualization 406 overlapping the Visual B and the user maintaining control of the group visualization 406 (e.g., via touch contact), the user is presented with an indication of where the first visual of the visualization group 404 (e.g., the Visual D) would be placed if the user dropped the group visualization 406. For instance, the Visual B is temporarily moved out of its place to indicate that the Visual D would be dropped in its location.

Continuing to the center portion of the scenario 400, the user holds the group visualization 406 in place for a particular period of time, e.g., more than one second. As a result, visuals displayed in the display area 402 are temporarily rearranged to provide a visual indication of how the display area 402 would appear if the user were to drop the group visualization 406 in its current location.

For example, visuals of the selection group 404 are arranged in a particular order, and other visuals are rearranged to accommodate the visuals of the selection group 404. Examples of logic for arranging visuals of a selection group and other visuals are discussed elsewhere herein. Thus, the visual arrangement presented in the center portion of the scenario 400 is a preview arrangement based on a current location of the group visualization 406. In at least some embodiments, the preview arrangement is not actually implemented unless a user drops the group visualization 406 at its current location.

Continuing to the lower portion of the scenario 400, the user manipulates the group visualization 406, such as slightly away from its previous position. In response, the visualizations in the display area 402 return to their previous positions, e.g., as displayed in the upper portion of the scenario 400.

Thus, the scenario 400 demonstrates an example way of displaying movement of visuals when multiple visuals are selected and manipulated. The scenario 400 is presented for purpose of example only, and a wide variety of different scenarios can be employed to display movement of multiple visuals in accordance with the claimed embodiments.

In at least some embodiments, notifications of visuals selected in multiple display areas can be presented to enable users to keep track of visual selections. For instance, consider the following scenario.

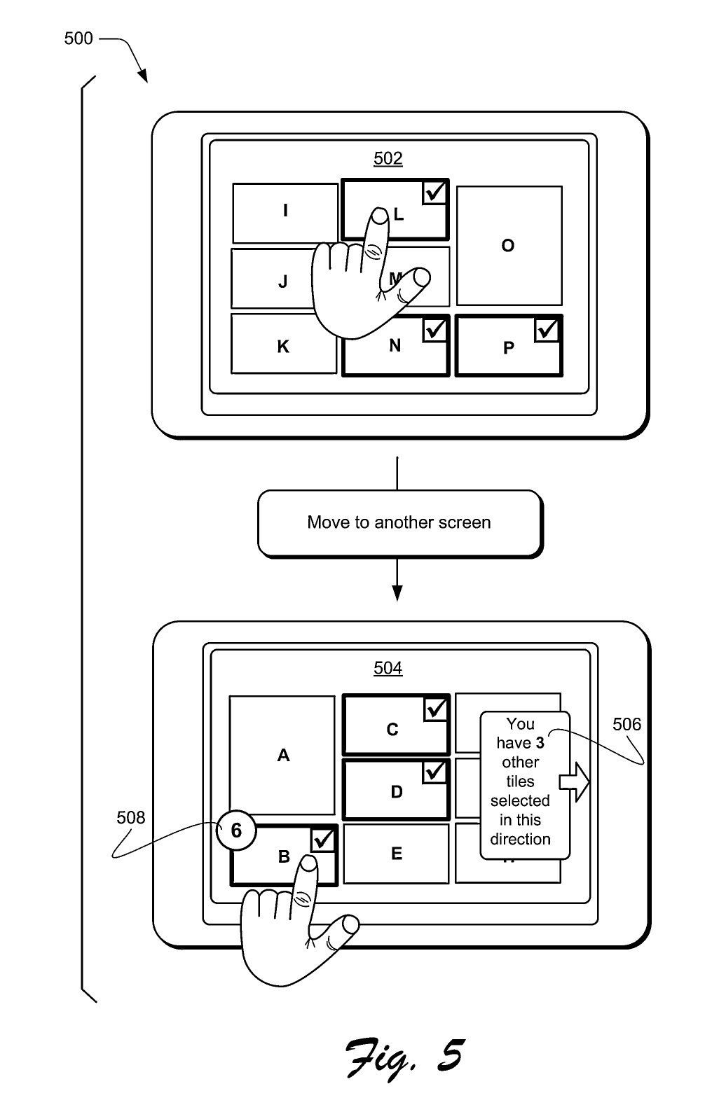

FIG. 5 illustrates an example implementation scenario, generally at 500. In the upper portion of the scenario 500, a user selects several visuals from a display area 502, e.g., a Visual L, a Visual N, and a Visual P.

Continuing to the lower portion of the scenario, the user moves to a display area 504, such as by scrolling away from the display area 502. For example, the user can drag the display area 502 to the right (e.g., via touch input) such that the display area 504 is presented. According to various embodiments, a wide variety of different input types and navigation modes may be employed to navigate between screens.

While the user moves away from the display area 502, the visuals selected in the display area 502 remain in a selected state. Thus, in response to the movement to the display area 504, a selection status notification 506 is presented that provides a graphical indication of visuals that are selected in other display areas that are not currently in view.

In the display area 504, the user selects several other visuals, e.g., a Visual B, a Visual C, and a Visual D. Thus, the visuals selected from the display area 504 are grouped together with the visuals previously selected from the display area 502 as part of a single selection group. Accordingly, a group indicator 508 is displayed that provides an indication of a number of visuals currently grouped together. As discussed above, a wide variety of graphical indicators can be used to indicate that multiple visuals are grouped together. As discussed herein, various actions can be applied to the grouped visuals as a group, such as moving the visuals, resizing the visuals, uninstalling associating functionality and/or deleting the visuals, and so forth.

In at least some embodiments, techniques can be employed to enable groups of visuals to be rearranged to minimize gaps between visuals and/or to conserve display space. For instance, consider the following scenario.

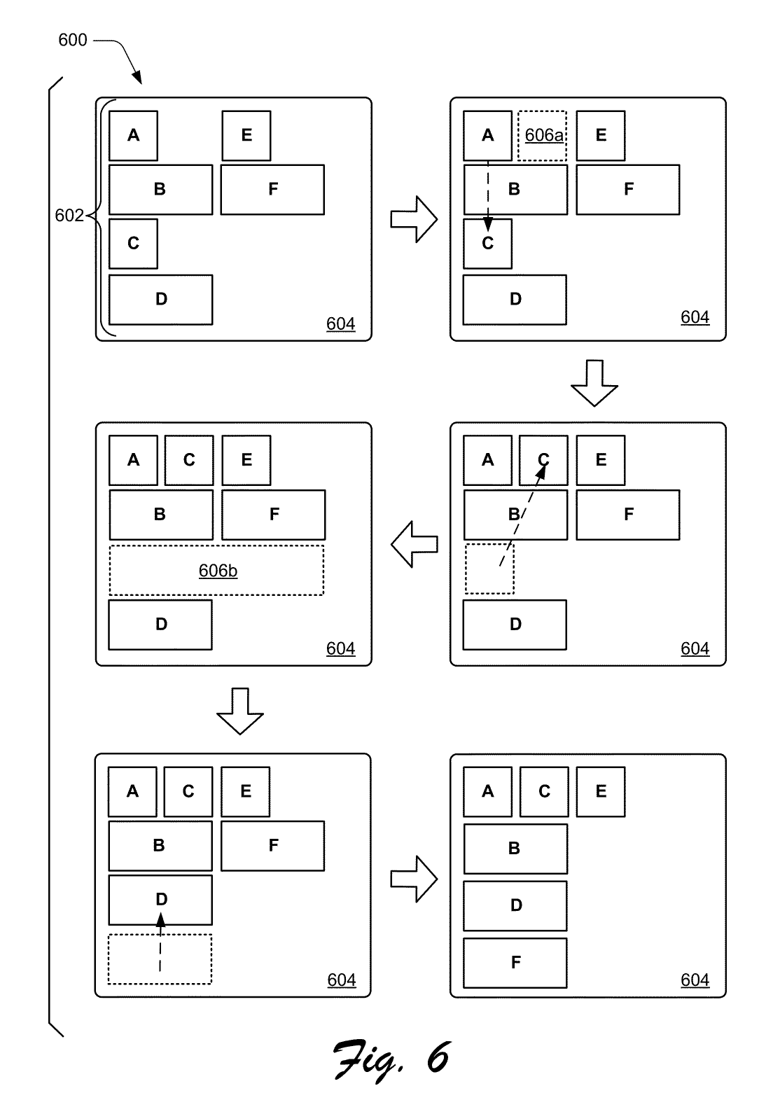

FIG. 6 illustrates an example implementation scenario, generally at 600. The upper left portion of the scenario 600 illustrates a group of visuals 602 that are displayed in a display region 604. The visuals 602 can be placed in response to a variety of different events. For example, a user may have selected and moved the visuals 602, such as via a multiple visual selection and movement discussed above. As another example, the visuals may have been sent to the display region 604 from another location, such as an application manager, a cloud resource (e.g., an application store), and so on.

Proceeding to the upper right portion of the scenario 600, a determination is made that the visuals 602 are to be rearranged. For example, gaps between the visuals are identified that can be filled by rearranging the visuals 602 to make more efficient use of the display region 604. In this example, Visual A is used as an origination point from which visual rearrangement can be initiated. Thus, the process starts at Visual A and iterates through the display region 604 based on visual order until a gap 606a is identified. Responsive to identification of the gap 606a, iteration through the visuals 602 begins again until a visual is location that can be placed in the gap 606a. As referenced above, Visual A is an origination point and thus is not considered when locating visuals to be moved. Thus, Visual C is identified as a visual that can be repositioned to fill the gap 606a.

Continuing downward to the center right portion of the scenario 600, the Visual C is repositioned to fill the gap 606a. Continuing to the center left portion of the scenario 600, a gap 606b is identified that is caused by repositioning of Visual C.

Proceeding to the lower left portion of the scenario 600 and utilizing the ongoing process, Visual D is identified as a visual that can fill at least a portion of the gap 606b. Thus, Visual D is repositioned accordingly.

Continuing to the lower right portion of the scenario 600, the process iterates several times until no fillable gaps remain between the visuals 602. Thus, as illustrated, usage of display space in the display region 604 for the visuals 602 is conserved by minimizing or eliminating gaps between the visuals 602.

According to one or more embodiments, the process described with reference to FIG. 6 can be performed for sub-groups and/or sub-regions of visuals displayed in a display region, and not performed for others. For instance, consider that other visuals besides the visuals 602 may be displayed in the display region 604. The process described for rearranging the visuals 602 may be applied to the visuals 602 without being applied to the other visuals. The other visuals, for example, may not be considered in locating visuals to fill a gap between the visuals 602. Thus, some areas of the display region 604 can be reconfigured to minimize and/or eliminate gaps between visuals, while other areas may be excluded from the process.

Having described some example implementation scenarios in which the techniques described herein may operate, consider now some example procedures in accordance with one or more embodiments.

### Example Procedures

The following discussion describes some example procedures for visual selection and grouping in accordance with one or more embodiments. The example procedures may be employed in the environment 100 of FIG. 1, the system 1000 of FIG. 10, and/or any other suitable environment. In at least some embodiments, the aspects of the procedures can be implemented by the visual manager module 112.

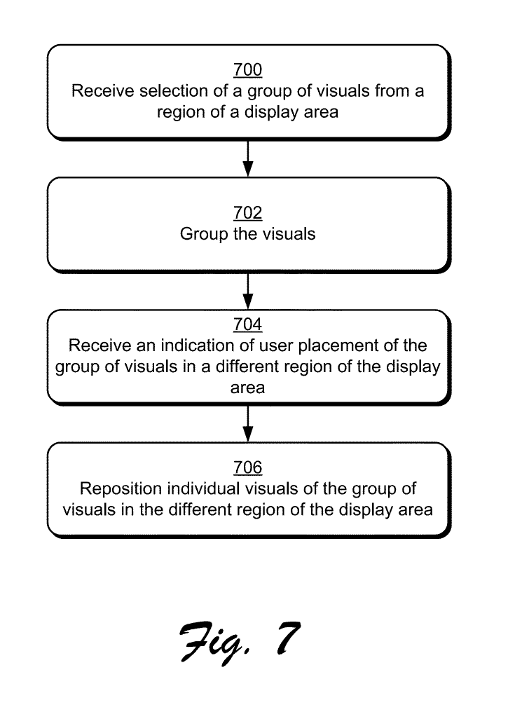

FIG. 7 is a flow diagram that describes steps in a method in accordance with one or more embodiments. Step 700 receives selection of a group of visuals from a region of a display area. As referenced above, multiple visuals can be selected while a multiple selection mode is active. Additionally or alternatively, specific types of input can indicate that visuals are to be grouped together as part of a selection group.

For example, a specific touch gesture can invoke a multiple selection mode, such that individual visuals to which the specific touch gesture is applied (e.g., individually) are grouped together. A specific touchless gesture may similarly be applied. A variety of other input types may be implemented, alternatively or additionally, to enable selection and grouping of visuals.

Step 702 groups the visuals. For example, a user can provide input that specifies that the visuals are to be aggregated as a group. As discussed above, for instance, a user can move one of the selected visuals in a display area. In response to the movement, selected visuals can be aggregated as a single visual representation of the group of selected visuals.

Step 704 receives an indication of user placement of the group of visuals in a different region of the display area. A user, for example, can manipulate a visual representation of the group of visuals to a particular region of a display area, such as via a drag and drop interaction with the visual representation.

Step 706 repositions individual visuals of the group of visuals in the different region of the display area. For example, the visuals can be arranged in the different region based on their original display order, e.g., before the visuals were moved by the user. However, a wide variety of different arrangement logic can be employed to rearrange and/or reorder visuals when they are selected as part of a selection group. For instance, consider the following examples of arrangement logic in accordance with various embodiments.

In at least some embodiments, visuals can be arranged based on the order in which they were selected. For example, visuals can be ordered in a visual group based on user selection, with a visual that is selected first being placed in a first position, a visual that is selected second in a second position, and so forth. Thus, in at least some embodiments, ordering based on user selection can be employed as an alternative to ordering based on display order. In such embodiments, rearrangement of visuals that are moved as a group can be based on selection order such that a first selected visual is placed first, and the remaining visuals placed in a display order following the first selected visual and based on their respective selection orders.

As another example, visuals can be reordered based on their respective sizes. For example, visuals can be rearranged such that when the visuals are placed in a new location, gaps between the visuals are minimized. Thus, a space conserving logic can be employed in determining a rearrangement order for visuals that are moved in a selection group.

As yet another example, visuals can be reordered based on level of user interaction with respective visuals and/or their underlying functionalities. For instance, visuals can be ranked based on user interaction with the visuals. Visuals that a user interacts with more can be ranked higher than visuals that experience less user interaction. Thus, higher ranked visuals can be ordered before lower ranked visuals in a rearrangement order.

A variety of other arrangement logic can be employed alternatively or in addition, such as based on visual color, content providers associated with visuals, and so forth.

In at least some embodiments, user placement of a group of visuals and/or a repositioning of placed visuals causes a multiple selection mode to be deactivated.

FIG. 8 is a flow diagram that describes steps in a method in accordance with one or more embodiments. In at least some embodiments, the method describes an example way of rearranging visuals to minimize gaps between visuals in a display region, such as discussed above with reference to FIG. 6.

Step 800 detects a gap between visuals displayed in a group of visuals. Gaps, for example, can correspond to spaces between visuals that are not occupied by other visual indicia, such as other visuals and/or other graphics. Gaps may also be filtered based on size. For example, a space between visuals that is not large enough to accommodate a visual may not be considered a gap, whereas a space that can accommodate at least one visual can be labeled as a gap.

As referenced above, a gap detection algorithm can be employed to scan a display region for gaps. For example, a display region can be characterized as a grid that overlays a group of visuals. The grid can be traversed to detect gaps between the visuals, and to determine the size of gaps that are detected.

Step 802 moves a visual of the group of visuals to fill the gap. For example, a visual can repositioned from a portion of a display area to a location that corresponds to the detected gap. According to the grid scenario referenced above, the grid can be traversed until a visual is located that can be placed in the gap. For instance, a visual that is too large to fit in the gap may be skipped, whereas a visual that is sufficiently small to fit in the gap may be identified and moved to fill the gap.

Step 804 ascertains whether a gap remains between the visuals of the group of visuals. For example, the grid referenced above can be traversed again to determine if any gaps remain after the first gap is filled. If a gap is detected (“Yes”), the method returns to step 802. If a gap is not detected (“No”), step 806 determines that no fillable gaps remain. For instance, some spaces between visuals may remain that are too small to be filled by moving and/or rearranging visuals. Such spaces are not considered to be gaps for purposes of triggering a movement and/or rearrangement of visuals.

In at least some embodiments, the method described above can be automatically invoked in response to various events. For instance, if a user selects multiple visuals and moves the visuals in a display region, the gap filling algorithm described above can be automatically invoked based on the movement to arrange the visuals to minimize or eliminate gaps. As another example, downloading and/or moving visuals to a display area from another location can automatically invoke this process.

For instance, consider a scenario where a user initiates a download of applications and/or content, such as from a cloud resource. Visuals that represent the applications and/or content can be generated and displayed. The process described above can be applied to the visuals to arrange the visuals to minimize or eliminate gaps between the visuals. These scenarios are provided for purpose of example only, and the gap filling algorithm discussed above can be employed in a variety of scenarios. Further, the algorithm is not limited to visual-based implementations, and can be employed to minimize or eliminate gaps between a variety of different visual indicia.

In at least some embodiments, grouping of visuals via multiple visual selection can enable various actions to be applied to visuals as a group. For instance, considered the following example procedure.

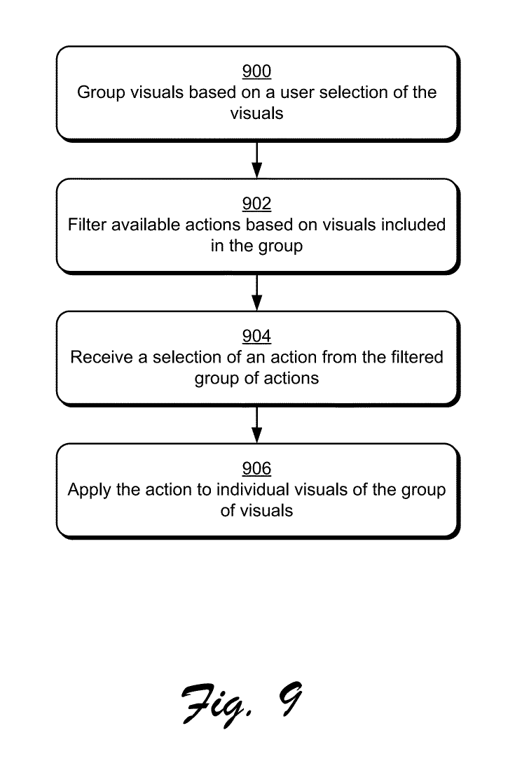

FIG. 9 is a flow diagram that describes steps in a method in accordance with one or more embodiments. Step 900 groups visuals based on a user selection of the visuals. For instance, various implementations discussed above can be employed to select and group visuals.

Step 902 filters available actions based on visuals included in the group. For instance, a general group of actions can be made available to be applied to visuals. The group of actions can be filtered based on various criteria that can be applied to attributes of visuals included in a selected group. The criteria, for example, can be applied to determine which actions of a group of actions are to be made available to be selected and applied to visuals of the group. For instance, consider the following example actions and some example criteria for consideration in determining whether the actions are presented for selection to be applied to a group of visuals:

Reduce Visual Size: This action is selectable to reduce a display size of a visual. For example, multiple preset sizes can be defined for visuals. A user can resize a visual between the preset sizes, such as by selecting a reduce visual size action. If a group of visuals includes a visual that is currently sized at a smallest available size, this action may not be presented. Otherwise, this action can be presented to resize selected visuals to a smaller size.

Increase Visual Size: This action is selectable to increase a display size of a visual. As referenced above, multiple preset sizes can be defined for visuals. A user can resize a visual between the preset sizes, such as by selecting an increase visual size action. If a group of visuals includes a visual that is currently sized at a largest available size, this action may not be presented. Otherwise, this action can be presented to resize selected visuals to a larger size.

Remove from Primary Screen: In at least some embodiments, a primary screen can be presented that includes various visuals. The primary screen, for instance, can correspond to an initial and/or default screen that is presented to a user when a device is powered up, e.g., booted. Various visuals can be presented by default in the primary screen. A user may customize the primary screen by adding and deleting visuals from the primary screen. To enable customization of a primary screen, the Remove action can be presented to enable certain visuals to be removed from the primary screen.

Activate Visual: In at least some embodiments, visuals can be dynamic in nature. For example, visuals can include rich content that can be dynamically changed, such as graphics that can change in response to various events. Thus, a visual that is dynamically changeable can be considered an “active visual,” whereas a visual that is not dynamically changeable can be considered an “inactive visual.”

In accordance with one or more embodiments, certain types of applications can support active visuals, whereas others do not. Thus, if a selected group of visuals does not support active visuals, the Activate Visual action may not be presented. Otherwise, the Active Visual action can be presented to enable inactive visuals to be activated.

Inactivate Visual: As referenced above, certain types of visuals are configured to include rich content that is dynamic in nature. Thus, this action is selectable to cause such visuals to be inactivated. Generally, inactivating a visual disables the dynamic aspect of a visual such that the visual is not dynamically updated with various types of content. If a group of selected visuals does not support active visuals, this action may not be presented. Otherwise, if at least one visual of a selected group supports active visuals and is currently active, this action can be presented to inactivate the visual.

Apply Gap Filling: This action can be presented to enable a user to opt-in or opt-out of gap filling for a particular group of selected visuals. For example, a user can select this option to cause a gap filling algorithm to be applied to a selected group of visuals, or to specify that gap filling is not to be applied to a selected group of visuals.

Uninstall: This action can be presented to enable applications associated with selected visuals to be uninstalled.

Delete: This action can be presented to enable applications and/or content associated with selected visuals to be deleted.

Clear Selection: This action can be presented to enable a selection of a group of visuals to be cleared.

The actions and criteria for filtering the actions listed above are presented for purpose of example only, and a wide variety of different actions and filtering criteria can be provided in accordance with the claimed embodiments.

Step 904 receives a selection of an action from the filtered group of actions. A user, for example, can select an available action from a user interface using any suitable form of input.

Step 906 applies the action to individual visuals of the group of visuals. Examples of actions that can be applied to visuals are listed above. Thus, embodiments enable a group of visuals to be selected, and an action that is available for the group of visuals to be applied to each of the visuals in the group.

Having discussed some example procedures, consider now a discussion of an example system and device in accordance with one or more embodiments.

### Example System and Device

FIG. 10 illustrates an example system generally at 1000 that includes an example computing device 1002 that is representative of one or more computing systems and/or devices that may implement various techniques described herein. For example, the computing device 102 discussed above with reference to FIG. 1 can be embodied as the computing device 1002. The computing device 1002 may be, for example, a server of a service provider, a device associated with the client (e.g., a client device), an on-chip system, and/or any other suitable computing device or computing system.

The example computing device 1002 as illustrated includes a processing system 1004, one or more computer-readable media 1006, and one or more Input/Output (I/O) Interfaces 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1100 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1010 and computer-readable media 1006 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of modules that are executable by the computing device 1002 as software may be achieved at least partially in hardware, e.g., through use of computer-readable storage media and/or hardware elements 1010 of the processing system. The instructions and/or functions may be executable/operable by one or more articles of manufacture (for example, one or more computing devices 1002 and/or processing systems 1004) to implement techniques, modules, and examples described herein.

As further illustrated in FIG. 10, the example system 1000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1000, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1002 may assume a variety of different configurations, such as for computer 1014, mobile 1016, and television 1018 uses. Each of these configurations includes devices that may have generally different constructs and capabilities, and thus the computing device 1002 may be configured according to one or more of the different device classes. For instance, the computing device 1002 may be implemented as the computer 1014 class of a device that includes a personal computer, desktop computer, a multi-screen computer, laptop computer, netbook, and so on.

The computing device 1002 may also be implemented as the mobile 1016 class of device that includes mobile devices, such as a mobile phone, portable music player, portable gaming device, a tablet computer, a multi-screen computer, and so on. The computing device 1002 may also be implemented as the television 1018 class of device that includes devices having or connected to generally larger screens in casual viewing environments. These devices include televisions, set-top boxes, gaming consoles, and so on.

The techniques described herein may be supported by these various configurations of the computing device 1002 and are not limited to the specific examples of the techniques described herein. For example, functionalities discussed with reference to the visual manager module 112 may be implemented all or in part through use of a distributed system, such as over a “cloud” 1020 via a platform 1022 as described below.

The cloud 1020 includes and/or is representative of a platform 1022 for resources 1024. The platform 1022 abstracts underlying functionality of hardware (e.g., servers) and software resources of the cloud 1020. The resources 1024 may include applications and/or data that can be utilized while computer processing is executed on servers that are remote from the computing device 1002. Resources 1024 can also include services provided over the Internet and/or through a subscriber network, such as a cellular or Wi-Fi network.

The platform 1022 may abstract resources and functions to connect the computing device 1002 with other computing devices. The platform 1022 may also serve to abstract scaling of resources to provide a corresponding level of scale to encountered demand for the resources 1024 that are implemented via the platform 1022. Accordingly, in an interconnected device embodiment, implementation of functionality described herein may be distributed throughout the system 1000. For example, the functionality may be implemented in part on the computing device 1002 as well as via the platform 1022 that abstracts the functionality of the cloud 1020.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

### CONCLUSION

Techniques for visual selection and grouping are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A device comprising:
at least one processor; and
one or more computer-readable storage media including instructions stored thereon that, responsive to execution by the at least one processor, cause the device to perform operations including:
grouping visuals selected from a first region of a display area and responsive to a user selection of the visuals;
receiving an indication of user placement of the group of visuals in a second region of the display area; and
repositioning individual visuals of the group of visuals in the second region of the display area based on at least one of an order in which the individual visuals were arranged in the first region of the display area, or an order in which the visuals were selected.

2. A device as recited in claim 1, wherein said grouping causes the visuals to be visually distinguished as a group from other visuals not selected as part of the group.

3. A device as recited in claim 1, wherein said grouping comprises displaying a group visualization that represents the group of visuals, and the user placement comprises a user placement of the group visualization in the second region of the display area.

4. A device as recited in claim 3, wherein the group visualization includes a visual indication of a number of visuals in the group of visuals.

5. A device as recited in claim 1, wherein said repositioning comprises placing the visuals of the group of visuals in the second region of the display area such that the order in which the individual visuals were arranged in the first region of the display area is preserved in the second region of the display area.

6. A device as recited in claim 1, wherein said repositioning comprises one or more of:
placing the visuals of the group of visuals in the second region of the display area such that the order in which the individual visuals were selected in the first region of the display area is used to arrange the visuals in the second region of the display area;
placing the visuals of the group of visuals in the second region of the display area based on respective sizes of the visuals; or
placing the visuals of the group of visuals in the second region of the display area based on a user interaction-based ranking of the respective visuals.

7. A device as recited in claim 1, wherein the operations further comprise repositioning one or more other visuals displayed in the second region of the display area and not included in the group of visuals such that the order in which the individual visuals of the group of visuals were arranged in the first region of the display area is preserved.

8. A device as recited in claim 1, wherein the operations further comprise repositioning one or more other visuals displayed in the second region of the display area to accommodate the repositioning of the group of visuals and such that a visual order of the one or more other visuals in the second region is preserved.

9. A device as recited in claim 1, wherein the operations further comprise:
detecting a gap between the visuals of the group of visuals displayed in the second region of the display area; and
moving one or more of the visuals of the group of visuals to fill the gap.

10. A device as recited in claim 9, wherein the operations further comprise:
detecting one or more other gaps between the visuals of the group of visuals displayed in the second region of the display area; and
moving one or more other visuals of the group of visuals to fill the one or more other gaps until no additional fillable gaps are detected.

11. One or more computer-readable storage media comprising instructions stored thereon that, responsive to execution by a computing device, cause the computing device to perform operations comprising:
grouping visuals into a visual group based on a user selection of the visuals;
filtering available actions based on attributes of the visuals included in the visual group;
receiving a selection of an action from the filtered group of actions; and
applying the action to the individual visuals of the visual group.

12. One or more computer-readable storage media as recited in claim 11, wherein said filtering comprises ascertaining that a particular action is not applicable to one of the visuals included in the visual group, and omitting the particular action from the filtered group of actions.

13. One or more computer-readable storage media as recited in claim 11, wherein said filtering comprises ascertaining that at least one of the visuals included in the visual group cannot be resized to a smaller size, and omitting an action from the filtered group of actions that is selectable to cause the visuals of the visual group to be resized to a smaller size.

14. One or more computer-readable storage media as recited in claim 11, wherein said filtering comprises ascertaining that at least one of the visuals included in the visual group cannot be resized to a larger size, and omitting an action from the filtered group of actions that is selectable to cause the visuals of the visual group to be resized to a larger size.

15. One or more computer-readable storage media as recited in claim 11, wherein at least some of the visuals included in the visual group represent respective applications, and wherein said applying causes an associated action to be applied to the respective applications.

16. A computer-implemented method, comprising:
detecting a gap between visuals displayed in a group of visuals;
moving a visual of the group of visuals to fill the gap by traversing through the visuals until a visual is located to fill the gap;
ascertaining whether one or more other gaps remain between the visuals of the group of visuals; and
in an event that one or more other gaps remain, moving at least one other visual of the group of visuals to fill the one or more other gaps.

17. A method as described in claim 16, wherein said detecting comprises identifying the gap as a space between visuals that is large enough to accommodate at least one visual.

18. A method as described in claim 16, wherein said detecting occurs in response to a user-initiated movement of the group of visuals between regions of a display area.

19. A method as described in claim 16, wherein the group of visuals is displayed in a display region that includes one or more other visuals, and wherein the one or more other visuals are not considered when traversing through the visuals to locate a visual to fill the gap.

20. A method as described in claim 16, wherein said traversing comprises skipping one or more visuals that are too large to fit in the gap.
